(19) United States
(12) Patent Application Publication
(10) Pub. No.: US 2008/0003487 A1
(43) Pub. Date: Jan. 3, 2008

(54) Powdery Metal Oxide Mother Particles, Powdery Metal Oxide Child Particles, Process for Producing Powdery Metal Oxide Particles, Powdery Composite Particles, and Electrode for Solid Oxide Fuel Cell

(75) Inventor: Koichi Takizawa, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: The Tokyo Electric Power Company, Incorporated, Chiyoda-ku (JP)

(21) Appl. No.: 11/575,549

(22) PCT Filed: Oct. 20, 2005
(86) PCT No.: PCT/JP05/19745

§ 371 Date: May 9, 2007

(30) Foreign Application Priority Data
Oct. 29, 2004 (JP) 2004-315692

(51) Int. Cl. H01M 8/10; B22F 9/24; B32B 15/02

(52) U.S. Cl. 429/46; 423/1; 428/402.24

(57) ABSTRACT

Powdery metal oxide mother particles (child particles) for use in electrode for solid oxide fuel cells, which have cavities or pores. A process for producing powder metal oxide particles, comprising a dispersion liquid preparation step of preparing a dispersion liquid containing a metal salt and a pore-forming agent, and a spray pyrolysis process of spraying the dispersion liquid in a heating furnace to prepare a powdery metal oxide. Powdery composite particles produced by using powdery metal oxide mother particles (child particles). There is also provided an electrode for solid oxide fuel cell According to the present invention, powdery metal oxide particles with a large specific surface area for use in an electrode for solid oxide fuel cells, a process for producing the metal oxide particles, powdery composite particles with a large specific surface area, and an electrode for solid oxide fuel cells can be provided.

### TECHNICAL FIELD

The present invention relates to a metal oxide used for producing an electrode for solid oxide fuel cells and an electrode for solid oxide fuel cells produced by using the same, and more particularly to powdery metal oxide mother particles, powdery metal oxide child particles, a process for preparing powdery metal oxide particles, powder composite particles prepared using the powdery metal oxide mother particles and powdery metal oxide child particles, and an electrode for solid oxide fuel cells.

### BACKGROUND ART

A cell of a solid oxide fuel cell has an electrolyte sandwiched by a fuel electrode and an air electrode. The electrolyte, fuel electrode and air electrode are formed of a metal oxide or a metal. Thus, the cell is entirely a solid.

In the solid oxide fuel cell, a cell reaction occurs in a three-phase interface in which all of the gases, the ions and the electrons are reactive. For this reason, the three-phase interface area must be increased in order to promote cell performance.

Conventionally, a method of increasing the three-phase interface area by mixing an electrolyte substance with an electrode substance, and further forming the electrode from a porous substance has been used. In this method, the three-phase interface is increased by increasing not only the contact area of the electrolyte substance with the electrode substance, but also by forming the three-phase interface in the electrode. Specifically, an electrode having a porous structure in which an electrolyte substance is mixed with an electrode substance was prepared by forming the electrode from powdery composite particles, in which either the mother particles or the child particles, the latter being fixed to the former is an electrolyte substance and the other is a fuel electrode substance or an air electrode substance. In the present invention, a fuel electrode substance refers to a substance capable of producing water and electrons from a hydrogen fuel and oxide ions, and capable of conducting electrons, an air electrode substance refers to a substance capable of producing oxide ions from oxygen and electrons and conducting electrons, and an electrolyte substance refers to a substance capable of conducting oxide ions generated in an air electrode to a fuel electrode.

As such composite particles and an electrode formed from the composite particles, for example, JP-A-10-144337 discloses composite particles comprising a metal having electrode activity (for example, nickel oxide) supported on the surface of an oxide having oxygen ion conductivity (for example, yttria-stabilized zirconia) and a fuel electrode for solid electrolyte fuel cells made from such composite particles (Example 1).

In order to increase the surface area of the composite particles for the purpose of increasing performance of the cell, it is necessary to decrease the particle sizes of the mother particles and child particles forming the composite particles. However, since there is a limit to decreasing the particle diameter in industrial manufacturing processes, it has been difficult to increase the specific surface areas of the composite particles and the fuel electrode JP-A-10-144337 to levels larger than specific values.

If the specific surface areas of the mother particles and child particles can be increased, it is possible to increase the specific surface area of the composite particles or the electrode.

Therefore, a object of the present invention is to provide powdery metal oxide particles with a large specific surface area for producing an electrode for solid oxide fuel cells, a process for producing the powdery metal oxide particles, composite particles with a large specific surface area, and an electrode for solid oxide fuel cells.

### DISCLOSURE OF THE INVENTION

As a result of extensive studies in order to achieve the above object, the inventors of the present invention have found that (1) powdery metal oxide particles having a large number of cavities and pores can be obtained by pyrolysis of a dispersion liquid containing combustible substances such as a metal salt and carbon powder by spraying the dispersion liquid in a heating furnace, (2) because the surface of the metal oxide particles can be hollowed by causing carbon powder and the like to sink into powdery metal oxide particles by applying a mechanical force to a mixture of powdery metal oxide particles and combustible materials such as carbon powder before molding, it is possible to obtain powdery metal oxide particles having cavities and pores on the surface, and (3) it is possible to increase the specific surface areas of composite particles and an electrode for solid oxide fuel cells as compared with conventional composite particles or conventional electrodes by using such powdery metal oxide particles.

Specifically, the invention (1) provides powder metal oxide mother particles having cavities or pores, which can be used as an electrode for solid oxide fuel cells.

The invention (2) provides powdery metal oxide child particles having cavities or pores, which can be used as an electrode for solid oxide fuel cells.

The invention (3) provides a process for producing powdery metal oxide particles having cavities or pores, comprising a step of preparing a dispersion liquid containing a metal salt and a pore-forming agent (dispersion liquid preparation step) and a step of spraying the dispersion liquid in a heating furnace to prepare powdery metal oxide particles having cavities or pores (spray pyrolysis step).

The invention (4) provides powdery composite particles comprising mother particles and child particles fixed to the mother particles, in which the mother particles are the powdery metal oxide mother particles described in the invention (1).

The invention (5) provides powdery composite particles comprising mother particles and child particles fixed to the mother particles, in which the child particles are the powdery metal oxide child particles described in the invention (2).

The invention (6) provides powdery composite particles comprising mother particles and child particles fixed to the mother particles, in which the mother particles are the powdery metal oxide mother particles described in the invention (1) and the child particles are the powdery metal oxide child particles described in the invention (2).

The invention (7) provides an electrode for solid oxide fuel cells obtained by molding the powdery composite particles described in any one of the inventions (4) to (6).

The invention (8) provides an electrode for solid oxide fuel cells obtained by preparing a slurry containing one or more types of powdery metal oxide mother particles described in the invention (1), molding the slurry into the form of an electrode, and baking the resulting molded article.

According to the present invention, powdery metal oxide mother particles or child particles with a large specific surface area for producing an electrode for solid oxide fuel cells, powdery composite particles with a large specific surface area, and an electrode for solid oxide fuel cells can be provided. In addition, powdery metal oxide mother particles having cavities or pores can be produced according to the present invention.

### BRIEF DESCRIPTION OF THE DRAWINGS

FIG. 1 shows schematic diagrams for illustrating metal oxide mother particles and child particles, and electrodes produced by using the mother particles and child particles of the present invention.

FIG. 2 is a schematic end view of a metal oxide mother particle child particle) of the present invention cut along an arbitrary plane.

FIG. 3 is an SEM photograph of metal oxide mother particles (child particles) of an embodiment of the present invention.

FIG. 4 shows a schematic diagram illustrating the manner in which metal oxide particles (F) having cavities or pores are produced from a dispersion liquid.

FIG. 5 shows schematic diagrams showing a production mechanism by which metal oxide particles having cavities (G) or pores are produced,

FIG. 6 is a schematic diagram showing a powder processing unit.

FIG. 7 is a sectional view of the powder processing unit cut along the X-X plane.

FIG. 8 are schematic diagrams illustrating the manner in which a welding force and a shear force are applied to a powder mixture 54.

FIG. 9 is a schematic diagram showing a composite particle.

FIG. 10 is a scanning electron microscope photograph of powdery metal oxide particles (vi) of Example 5.

FIG. 11 is a transmission electron microscope photograph of powdery metal oxide particles (vi) of Example 5.

FIG. 12 is a scanning electron microscope photograph of an electrode (vii) of Example 5.

### BEST MODE FOR CARRYING OUT THE INVENTION

The powdery metal oxide mother particles and powdery metal oxide child particles of the present invention are used as an electrode-forming material, that is, as a raw material for producing an electrode for solid oxide fuel cells (hereinafter referred to from time to time simply as “electrode”). The powdery metal oxide mother particles and powdery metal oxide child particles are an aggregate (secondary particles) in which the metal oxides (primary particles) are aggregated. In the present invention, “powdery metal oxide mother particles” refers to each particle (secondary particles) of the powdery metal oxide mother particles or the aggregate of the particles (secondary particles) (the same applies to the powdery metal oxide child particles).

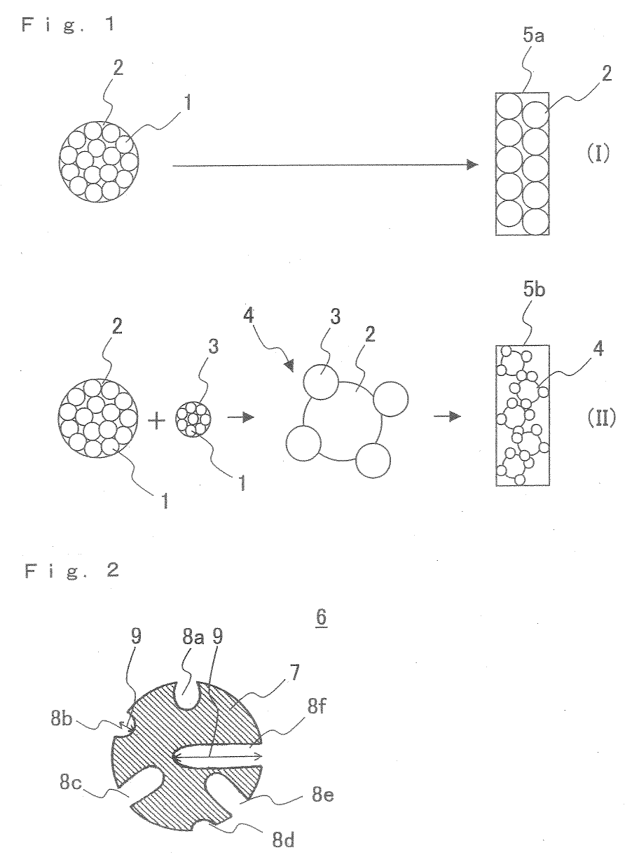

The powdery metal oxide mother particles, the powdery metal oxide child particles, and the electrode of the present invention will now be explained with reference to FIG. 1. In the following description, a reference to mother particles (child particles)” indicates that the explanation applies to both the mother particles and the child particles. FIG. 1 shows schematic diagrams for illustrating metal oxide mother particles and child particles, and electrodes produced by using the mother particles and child particles. As shown in FIG. 1, the electrode is produced either by a method in which the electrode is produced only from mother particles (FIG. 1 (I)) or by a method in which composite particles are first produced and the electrode is produced using the composite particles (FIG. 1 (II)) In the case of FIG. 1 (I), a powdery metal oxide mother particle 2 (secondary particle) indicates one particle forming the powdery metal oxide mother particles. This is a metal oxide aggregate formed by agglomeration of metal oxide 1 (primary particles). An electrode 5a is prepared using a number of metal oxide mother particles 2. Next, the method of FIG. 1(II) will be described. The metal oxide mother particle 2 is the same as that of FIG. 1(I). A metal oxide child particle 3 indicates one particle forming the powdery metal oxide child particles. This is a metal oxide aggregate formed by agglomeration of metal oxide 1. A composite particle 4 in which the metal oxide child particles 3 are fixed to metal oxide mother particles 2 is first produced, then the electrode 5a is prepared using a number of composite particles 4. Although the metal oxide mother particle 2 and metal oxide child particle 3 have cavities or pores, these cavities or pores are omitted from FIG. 1 for ease of explanation.

There are the following metal oxide mother particles (child particles): (1) metal oxide mother particles (child particles) used as an electrolyte substance (hereinafter referred to from time to time as “powdery metal oxide mother particles (child particles) (A)”), (2) metal oxide mother particles (child particles) used as a fuel electrode substance (hereinafter referred to from time to time as “powder metal oxide mother particles (child particles) (B)”), (3) metal oxide mother particles (child particles) used as an air electrolyte substance (hereinafter referred to from time to time as “powdery metal oxide mother particles (child particles) (C)”), (4) metal oxide mother particles (child particles) used as both an electrolyte substance and a fuel electrode substance (hereinafter referred to from time to time as “powdery metal oxide mother particles (child particles) (D)”), and (5) metal oxide mother particles (child particles) used as both an electrolyte substance and an air electrode substance (hereinafter referred to from time to time as “powdery metal oxide mother particles (child particles) (E)”).

The powdery metal oxide mother particles (child particles) (A) are formed from an oxide of one or more metals selected from the group consisting of yttrium (Y), zirconium (Zr), scandium (Sc), cerium (Ce), samarium (Sm), aluminum (Al), titanium (Ti), magnesium (Mg), lanthanum (La), gallium (Ga), niobium (Nb), tantalum (Ta), silicon (Si), gadolinium (Gd), strontium (Sr), ytterbium (Yb), iron (Fe), cobalt (Co), and nickel (Ni). Among the metal oxides forming the powdery metal oxide mother particles (child particles) (A), oxides containing two or more metals include, for example, scandia-stabilized zirconia (ScSZ; Sc₂O₃—ZrO₂), yttria-stabilized zirconia (YSZ; Y₂O₃—ZrO₂), lanthanum gallate such as lanthanum strontium magnesium gallate (LSGM; La_{0.8}Sr_{0.2}Ga_{0.8}Mg_{0.2}O₃), gadolinia-stabilized zirconia (Gd₂O₃—ZrO₂), samaria-doped ceria (Sm₂O₃—CeO₂), gadolinia-dope ceria (Gd₂O₃—CeO₂), and yttrium oxide-dispersed bismuth oxide (Y₂O₃—Bi₂O₃) Of these, scandia-stabilized zirconia, yttria-stabilized zirconia, lanthanum gallates such as lanthanum strontium magnesium gallate, and the like are preferable due to excellent oxygen ion conductivity and thermal stability at operating temperatures. Samaria-doped ceria and gadolinia-doped ceria which possess both ionic conductivity and electronic conductivity can be used not only as the metal oxide of an electrolyte substance, but also as the metal oxide of a fuel electrode substance by mixing with nickel oxide as described later. The powdery metal oxide mother particles (child particles) (A) are an aggregate of one or more metal oxides constituting the powdery metal oxide mother particles (child particles) (A). Specifically, the powdery metal oxide mother particles (child particles) (A) are an aggregate of one or more metal oxides which are electrolyte substances.

When the powdery metal oxide mother particles (child particles) (A) are made from a metal oxide of two or more metals, the powdery metal oxide mother particles (child particles) (A) may be an aggregate of a mixture of two or more oxides such as a mixture of an oxide of metal X and an oxide of metal Y, an aggregate of a solid solution of an oxide of metal X and an oxide of metal Z (X-Z oxide solid solution), or an aggregate of a mixture of an oxide and a solid solution such as a mixture of a oxide of metal Y and a solid solution of a oxide of metals X and Z. This applies to all of the powdery metal oxide mother particles (child particles) (B) to (E).

The powdery metal oxide mother particles (child particles) (B) are formed from an oxide of one or more metals selected from the group consisting of yttrium, zirconium, scandium, cerium, samarium, aluminum, titanium, magnesium, lanthanum, gallium, miobium, tantalum, silicon, gadolinium, strontium, ytterbium, iron, cobalt, nickel, and calcium (Ca). For example, an aggregate of a mixture of nickel oxide (NiO) and the samaria-dope ceria (Sm₂O₃—CeO₂); an aggregate of a mixture of nickel oxide and yttria-stabilized zirconia (NiO—YSZ); an aggregate of a mixture of nickel oxide and scandia-stabilized zirconia (NiO—ScSZ); an aggregate of a mixture of nickel oxide, yttria-stabilized zirconia, and samaria-doped ceria; an aggregate of a mixture of nickel oxide, scandia-stabilized zirconia, and samaria-doped ceria; a aggregate of a mixture of nickel oxide, yttria-stabilized zirconia, and ceria oxide (CeO₂); a aggregate of a mixture of nickel oxide, scandia stabilized zirconia, and ceria oxide; an aggregate of a mixture of cobalt oxide (Co₃O₄) and yttria-stabilized zirconia; an aggregate of a mixture of cobalt oxide and scandia-stabilized zirconia; a aggregate of a mixture of ruthenium oxide (RuO₂) and yttria-stabilized zirconia; an aggregate of a mixture of ruthenium oxide and scandia-stabilized zirconia; and an aggregate of a mixture of nickel oxide and gadolinia-doped ceria (Gd₂O₃—CeO₂) can be given. Among these, an aggregate of a mixture of nickel oxide and samaria-doped ceria, an aggregate of a mixture of nickel oxide, and yttria-stabilized zirconia, and an aggregate of a mixture of nickel oxide and scandia-stabilized zirconia are preferable owing to their properties of not reacting with electrolyte substances and the capability of being easily bonded to electrolyte substances due to their close coefficients of other al expansion. The powdery metal oxide mother particles (child particles) (B) are an aggregate of one or more metal oxides constituting the powdery metal oxide mother particles (child particles) (B). Specifically, the powdery metal oxide mother particles (child particles) (B) are an aggregate of one or more metal oxides which are fuel electrode substances.

The powdery metal oxide mother particles (child particles) (C) are formed from an oxide of one or more metals selected from the group consisting of yttrium, zirconium scandium, cerium, samarium, aluminum, titanium, magnesium, lanthanum, gallium, niobium, tantalum, silicon, gadolinium, strontium, ytterbium, iron, cobalt, nickel, calcium (Ca), and manganese (Mn). Among the metal oxides which constitute the powdery metal oxide mother particles (child particles) (C), as metal oxides containing two or more types of metals, lanthanum strontium manganate (La_{0.8}Sr_{0.2}MnO₃), lanthanum calcium cobaltate (La_{0.9}Ca_{0.1}CoO₃), lanthanum strontium cobaltate (La_{0.9}Sr_{0.1}CoO₃), lanthanum cobaltate (LaCo₃), lanthanum calcium manganate (La_{0.9}Ca_{0.1}MnO₃), and the like can be given. Of these oxides, lanthanum strontium manganate is preferable owing to its properties of not reacting with electrolyte substances and capability of being easily bonded to electrolyte substances due to their close coefficients of thermal expansion. The powder metal oxide mother particles (child particles) (C) are an aggregate of one or more metal oxides constituting the powdery metal oxide mother particles (child particles) (C). Specifically, the powdery metal oxide mother particles (child particles) (C) are an aggregate of one or more metal oxides which are air electrode substances.

The powdery metal oxide mother particles (child particles) (D) are an aggregate containing one or more metal oxides constituting the powdery metal oxide mother particles (child particles) (A) and one or more metal oxides constituting the powdery metal oxide mother particles (child particles) (B). Specifically, the powdery metal oxide mother particles (child particles) (D) are an aggregate containing one or more metal oxides which are electrolyte substances and one or more metal oxides which are fuel electrode substances.

The powdery metal oxide mother particles (child particles) (E) are an aggregate containing one or more metal oxides constituting the powdery metal oxide mother particles (child particles) (A) and one or more metal oxides constituting the powdery metal oxide mother particles (child particles) (C). Specifically, the powdery metal oxide mother particles (child particles) (E) are an aggregate containing one or more metal oxides which are electrolyte substances and one or more metal oxides which are air electrode substances.

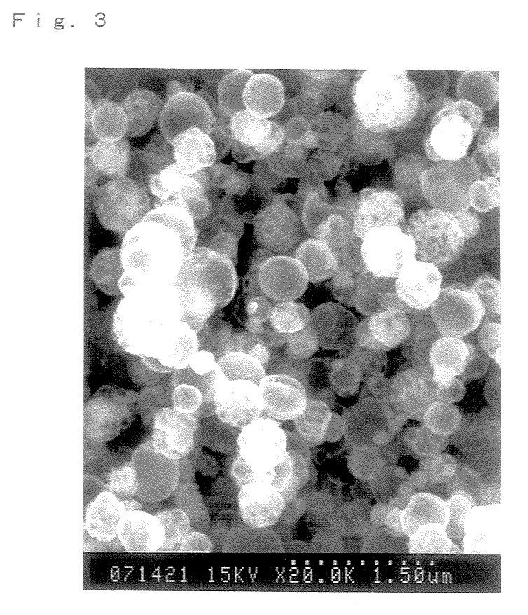

The powdery metal oxide mother particles (child particles) have cavities or pores. The cavities or pores will be described with reference to FIG. 2. FIG. 2 is a schematic end view of a powdery metal oxide mother particle (child particle) of the present invention cut along an arbitrary plane. In FIG. 2, a powder metal oxide mother particle 6 has cavities or pores 8a to 8f. Cavities 8a, 8b, and 8d have a shape in which the surface of a metal oxide aggregate 7 is depressed. On the other hand, pores 8c, 8e, and 8f are continuous holes extending from the core to the surface of the metal oxide aggregate 7. Specifically, cavities in the present invention refer to depressions on the surface of the metal oxide aggregate 7 and pores refer to continuous holes extending from the core to the surface of the metal oxide aggregate 7. The cavities and pores differ from each other only in their depth from the surface and they can not be clearly distinguished.

In order to ensure the same degree of mechanical strength as mother particles child particles) which do not have cavities or pores used for producing a conventional electrode and a specific surface area larger than that of mother particles (child particles) which do not have cavities or pores used for producing a conventional electrode, the powdery metal oxide mother particles (child particles) are preferably particles having many cavities on the surface and only a small number of continuous holes extending to inside of the particles. On the other hand, in order to provide the powdery metal oxide mother particles (child particles) with a remarkably large specific surface area, powdery metal oxide mother particles (child particles) having many continuous holes extending to the core of the particles are preferable.

Cavities or cores on the surface of powdery metal oxide mother particles (child particles) can be confirmed by surface observation using a scanning electron microscope (SEM) FIG. 3 is an SEM photograph of metal oxide mother particles (child particles) of an embodiment of the present invention. As shown in FIG. 3, the presence of cavities or cores on the surface of the powdery metal oxide mother particles (child particles) can be confirmed. On the other hand, continuous holes extending to the core of the powdery metal oxide mother particles (child particles) can be confirmed by enveloping the powdery metal oxide mother particles (child particles) with a resin, slicing the resin to obtain a thin film, and inspecting the film using a transmission electron microscope (TEM).

The specific surface area of the powdery metal oxide mother particles (child particles) is preferably from 3 to 30 m²/g, more preferably from 4 to 25 m²/g, and particularly preferably from 5 to 20 m²/g. If the specific surface area of the powdery metal oxide mother particles (child particles) is less than 3 m ²/g, it is difficult to obtain composite particles or an electrode having a large specific surface area. If the specific surface area is more than 30 m²/g, the metal oxide mother particles (child particles) become brittle and their shape is easily broken when composite particles or electrodes are prepared. The surface area of the powdery metal oxide mother particles (child particles) can be measured using a BET method.

Although not particularly limited, the average particle diameter of the powdery metal oxide mother particles is preferably from 0.1 to 100 micrometers, particularly preferably from 0.1 to 20 micrometers, and still more preferably from 0.1 to 10 micrometers, and the average particle diameter of the powdery metal oxide child particles is preferably from 0.01 to 10 micrometers, particularly preferably from 0.01 to 5 micrometers, and still more preferably from 0.01 micrometers to 1 micrometer.

Since the powdery metal oxide mother particles (child particles) of the present invention have cavities on the surface or pores inside the particles, the particles have a large specific surface area as compared with conventional mother particles or child particles for producing electrodes.

The powdery metal oxide mother particles (child particles) of the present invention are formed into an electrode either alone or mixed with other electrode-forming materials.

A process for producing the powdery metal oxide particles having cavities or pores according to a first embodiment of the present invention (hereinafter referred to from time to time as “production process of the first embodiment”) comprises a dispersion liquid preparation step and a spray pyrolysis step.

The spray pyrolysis step will be described first. The spray pyrolysis step is a step of preparing a dispersion liquid containing a metal salt and a pore-forming agent.

The metal salt used in the production process of the first embodiment differs depending on the powdery metal oxide particles having cavities or pores produced in the first process (the powdery metal oxide particles having cavities or pores produced in the production process of the first embodiment are hereinafter referred to from time to time as “powder metal oxide particles (F)”) (see the following (6) to (10)).

(6) When producing powdery metal oxide particles (F) having cavities or pores used as all electrolyte substance, there are no specific limitations to the metal salt used insofar as the metal salt can be converted into an electrolyte substance by oxidation. As examples of such a metal salt salts of one or more metals selected from the group consisting of yttrium zirconium, scandium, cerium, samarium, aluminum, titanium, magnesium, lanthanum, gallium, niobium, tantalum, silicon, gadolinium, strontium, ytterbium iron, cobalt, and nickel can be given. The types of salts are not specifically limited and include, for example, carbonates, sulfates, nitrates, and chlorides. As specific examples of the metal salt, zirconium carbonate, zirconium nitrate, yttrium nitrate, and cesium chloride can be given. The metal salt may be either a combination of two or more metal salts of the same metal or a combination of two or more metal salts of different metals.

(7) When producing powdery metal oxide particles (F) having cavities or pores used as a fuel electrode substance, there are no specific limitations to the metal salt used insofar as the metal salt can be converted into a fuel electrode substance by oxidation. As examples of such a metal salt, salts of one or more metals selected from the group consisting of yttrium, zirconium, scandium, cerium, samarium, aluminum, titanium, magnesium, lanthanum, gallium, niobium, tantalum, silicon, gadolinium, strontium, ytterbium, iron, cobalt, nickel, and calcium can be given. The types of salt are not specifically limited and include, for example, carbonates, sulfates, nitrates, and chlorides. As specific examples of the metal salt, nickel carbonate, nickel sulfate, nickel nitrate, and cerium nitrate can be given. The metal salt may be either a combination of two or more metal salts of the same metal or a combination of two or more metal salts of different metals.

(8) When producing powdery metal oxide particles (F) having cavities or pores used as an air electrode substance, there are no specific limitations to the metal salt used insofar as the metal salt can be converted into an air electrode substance by oxidation. As examples of such a metal salt, salts of one or more metals selected from the group consisting of yttrium, zirconium, scandium, cerium, samarium, aluminum, titanium, magnesium, lanthanum, gallium, niobium, tantalum, silicon, gadolinium, strontium, ytterbium, iron, cobalt, nickel, manganese, and calcium can be given. The types of salt are not specifically limited and include, for example, carbonates, sulfates, nitrates, and chlorides. As specific examples of the metal salt, strontium carbonate, lanthanum nitrate, manganese nitrate, and cobalt carbonate can be given. The metal salt may be either a combination of two or more metal salts of the same metal or a combination of two or more metal salts of different metals.

(9) When producing powdery metal oxide particles (F) having cavities or pores used either as an electrolyte substance or a fuel electrode substance, a mixture containing one or more types of metal salts for producing powdery metal oxide particles (F) having cavities or pores used as an electrolyte substance (6) and one or more types of metal salts for producing powdery metal oxide particles (F) having cavities or pores used as a fuel electrode substance (7) can be used. Specifically, when the powdery metal oxide particles (F) having cavities or pores used either as an electrolyte substance or a fuel electrode substance (9) are produced, the metal salt is a mixture of one or more metal salts converted into an electrolyte substance by oxidation and one or more types of metal salts converted into a fuel electrode substance by oxidation.

(10) When producing powdery metal oxide particles (F) having cavities or pores used either as an electrolyte substance or an air electrode substance, a mixture containing one or more types of metal salts for producing powdery metal oxide particles (F) having cavities or pores used as an electrolyte substance (6) and one or more types of metal salts for producing powdery metal oxide particles (F) having cavities or pores used as an air electrode substance (8) can be used. Specifically, when the powdery metal oxide particles (F) having cavities or pores used either as an electrolyte substance or an air electrode substance (10) are produced, the metal salt is a mixture of one or more metal salts converted into an electrolyte substance by oxidation and one or more types of metal salts converted into a fuel electrode substance by oxidation.

The pore-forming agent used in the production process of the first embodiment of the present invention is not specifically limited. Any compounds which are not dissolved in the solvent used for the dispersion liquid, present as a solid in the dispersion liquid, and destructed by burning in the spray pyrolysis step can be used as the pore-forming agent. As examples of the pore-forming agent, carbon powder, thermoplastic resin powder, thermoplastic resin fibers, thermosetting resin powder, thermosetting resin fibers, natural fibers, and derivatives of natural fibers can be given.

Examples of the carbon powder used as a pore-forming agent include, but are not limited to, carbon black, activated carbon, graphite, and amorphous carbon. The content of the metal component in the carbon powder is preferably 100 mg/kg or less. Carbon powder not containing a metal component is particularly preferable.

The thermoplastic resin powder, thermoplastic resin fibers, thermosetting resin powder, and thermosetting resin fibers used as the pore-forming agent are not particularly limited insofar as the pore-forming agent is destructed by burning in the spray pyrolysis step. For example, hydrocarbon compounds such as polyvinyl butyral and polystyrene, or compounds containing atoms other than carbon and hydrogen, such as oxygen-containing organic compounds such as polymethyl methacrylate, a phenol resin, and an epoxy resin, nitrogen-containing compounds such as polyamide, a melamine resin, a urea resin, and polyurethane, and sulfur-containing compounds such as polysulfone can be given. Of these, hydrocarbon compounds and oxygen-containing organic compounds which do not generate gases other than carbon dioxide gas during burning are preferable.

As examples of the natural fibers used as a pore-forming agent, cellulose fibers and protein fibers can be given. The cellulose fibers include semi-artificial acetate and rayon. As examples of derivatives of natural fibers used as a pore-forming agent, ethyl esters of natural fibers such as ethyl cellulose can be given.

When the pore-forming agent is a powder such as carbon powder, thermoplastic resin powder, or thermosetting resin powder, the average particle diameter of the powdery pore-forming agent is preferably from 0.001 to 10 micrometers, particularly preferably from 0.001 micrometers to 1 micrometer, and still more preferably from 0.01 micrometers to 1 micrometer, although a specific average particle diameter depends on the powdery metal oxide particles (F) having cavities or pores to be produced.

Although not particularly limited, the ratio of the average particle diameter of the powdery pore-forming agent (carbon powder, thermoplastic resin powder, or thermosetting resin powder) to the average particle diameter of the powdery metal oxide particles (F) having cavities or pores (powdery pore-forming agent/powdery metal oxide particles (F)) is usually in a range from 0.001 to 0.5, preferably from 0.01 to 0.2, and particularly preferably from 0.01 to 0.1. The smaller the ratio of the average particle diameter of the powdery pore-forming agent to the average particle diameter of the powdery metal oxide particles (F) having cavities or pores, the larger the specific surface area of the powdery metal oxide particles (F). However, if the ratio of the average particle diameters is less than 0.001, since the powder of the pore-forming agent easily aggregates in the dispersion liquid, it is difficult to form fine cavities or pores. If the ratio is more than 0.5, the powdery metal oxide particles (F) having cavities or pores tend to become brittle.

When the pore-forming agent is fibers such as thermoplastic resin fibers, thermosetting resin fibers, natural fibers, or derivatives of natural fibers, although the average fiber diameter and the average fiber length of the fibrous pore-forming agent depend on the average powdery metal oxide particles (F) having cavities or pores to be produced, the average fiber diameter is preferably from 0.01 to 50 micrometers, and particularly preferably from 0.1 to 10 micrometers, and the average fiber length is preferably from 0.01 to 100 micrometers, and particularly preferably from 0.1 to 50 micrometers.

Although not particularly limited, the ratio of the average fiber diameter of the fibrous pore-forming agent (thermoplastic resin fibers, thermosetting resin fibers, natural fibers, or derivatives of natural fibers) to the average particle diameter of the powdery metal oxide particles (F) having cavities or pores is preferably from 0.001 to 0.5, particularly preferably from 0.01 to 0.2, and still more preferably from 0.01 to 0.1. The smaller the ratio of the average fiber diameter of the fibrous pore-forming agent to the average particle diameter of the powdery metal oxide particles (F) having cavities or pores, the larger the specific surface area of the powdery metal oxide particles (F). However, if the ratio of the average fiber diameters is less than 0.001, since the fibers of the pore-forming agent easily aggregate in the dispersion liquid, it is difficult to form fine cavities or pores. If the ratio is more than 0.5, the powdery metal oxide particles (F) having cavities or pores tend to become brittle.

In the production process of the first embodiment of the present invention, if the dispersion liquid in which the pore-forming agent abundantly exists close to the surface is heated in a heating furnace, powdery metal oxide particles (F) with many cavities close to the surface are obtained. On the other hand, if the dispersion liquid in which the pore-forming agent abundantly exists around the center is heated in a heating furnace, powdery metal oxide particles (F) with many pores around the center are obtained.

When the pore-forming agent is a powder, the density of the pore-forming agent is smaller than the density of the liquid used for dispersing the pore-forming agent. Therefore, it is easier for fine particles of the powdery pore-forming agent to come close to the surface of a droplet of the dispersion liquid in which the pore-forming agent particles are dispersed, if the average particle diameter of the pore-forming agent is large. Therefore, the larger the average particle diameter of the pore-forming agent, easier it is to obtain a dispersion liquid in which the pore-forming agent abundantly exists close to the surface, that is, easier it is to obtain powdery metal oxide particles (F) with many cavities close to the surface. On the other hand, the smaller the average diameter of particles of the pore-forming agent, easier it is to obtain a dispersion liquid in which the pore-forming agent abundantly exists close to the center of the droplet, that is, easier it is to obtain powdery metal oxide particles (F) with many continuous holes in the core. Accordingly, in order to produce the powdery metal oxide particles (F) having many cavities or pores close to the surface, the average particle diameter of the powdery pore-forming agent is preferably more than 0.5 micrometers particularly preferably from 0.5 to 1.5 micrometers, and still more preferably from 0.7 micrometers to 1.0 micrometer. In order to produce the powdery metal oxide particles (F) with many continuous holes in the core, the average particle diameter of the powdery pore-forming agent is preferably less than 1.0 micrometer, particularly preferably from 0.01 to 0.6 micrometers, and still more preferably from 0.05 to 0.4 micrometers.

In the case of a fibrous pore-forming agent made from fibers such as To thermoplastic resin fibers, thermosetting resin fibers, natural fibers, and derivatives of natural fibers, the fibrous pore-forming agent comes close to the surface of a droplet of the dispersion liquid more easily than the powdery pore-forming agent.

As the pore-forming agent, two or more of the carbon powder, thermoplastic resin powder, thermoplastic resin fibers, thermosetting resin powder, thermosetting resin fibers, natural fibers, and derivatives of natural fibers may be used in combination.

The metal salt may be dissolved and present as an aqueous solution in the dispersion liquid, or solid particles of the metal salt may be suspended in the dispersion liquid. When it is difficult to dissolve the metal salt in water, an acid may be added to dissolve the metal salt. The pore-forming agent exists in the dispersion liquid as a suspension dispersed in the dispersion medium.

The content of the metal salt in the dispersion liquid is preferably from 0.001 to 100 mol/L, more preferably from 0.001 to 10 mol/L, and particularly preferably from 0.01 to 10 mol/L. If the content of the metal salt in the dispersion liquid is less than 0.001 mol/L, powdery metal oxide particles may not be produced or the powdery metal oxide particles (F) having cavities or pores tend to become brittle, and if more than 100 mol/L, the metal salt tends to clog nozzles and the like.

In addition because the particle diameter of the powdery metal oxide particles (F) having cavities or pores varies according to the content of the metal salt in the dispersion liquid, the average particle diameter of the powdery metal oxide particles (F) having cavities or pores can be controlled by appropriately selecting the content of the metal salt.

Although the content of the pore-forming agent in the dispersion liquid is not specifically limited, the content of the pore-forming agent is usually from 0.001 to 30 mass % preferably from 0.01 to 10 mass %, and particularly preferably from 0.01 to 5 mass %. If the content of the pore-forming agent in the dispersion liquid is less than 0.001 mass %, it is difficult for the powder metal oxide particles (F) having cavities or pores to have a large specific surface area, and if more than 30 mass %, too many cavities or pores are produced, resulting in brittle powdery metal oxide particles (F) having cavities or pores.

Although not specifically limited, the ratio of the content of the pore-forming agent to the content of the metal salt (mass % of the pore-forming agent/mass % of the metal salt) is preferably from 0.001 to 10, and particularly preferably from 0.01 to 1. The ratio of the content of the pore-forming agent to the content of the metal salt in the above range ensures powder metal oxide mother particles (F) having cavities or pores with a well-balanced specific surface area and strength. If the above ratio is less than 0.001, the specific surface area of the powdery metal oxide particles (F) is too small, and if more than 10 the powdery metal oxide particles (F) having cavities or pores tend to become brittle.

Moreover, the smaller the content of the pore-forming agent in the dispersion liquid the easier it is to obtain a dispersion liquid in which a large amount of the pore-forming agent exists near the surface. On the other hand, the larger the content of the pore-forming agent in the dispersion liquid, the easier it is to obtain a dispersion liquid in which a large amount of the pore-forming agent exists inside the particles. For this reason in order to produce the powdery metal oxide particles (F) with many cavities closer to the surface, the content of the pore-forming agent in the dispersion liquid is preferably less than 1 mass %, particularly preferably from 0.005 to 0.5 mass %, and still more preferably from 0.05 to 0.5 mass %. In addition, in order to produce the powdery metal oxide particles (F) with many continuous holes inside the particles, the content of the pore-forming agent in the dispersion liquid is preferably more than 0.1 mass %, particularly preferably from 0.5 to 10 mass %, and still more preferably from 1 to 5 mass %.

Thus, according to the production process of the first embodiment of the present invention, either the powdery metal oxide particles (F) having many cavities close to the surface or the powder metal oxide particles (F) having continuous holes inside the particles can be obtained by appropriately selecting the type of the pore-forming agent, the average particle diameter of the powdery pore-forming agent, or the content of the pore-forming agent in the dispersion liquid.

The method for preparing the dispersion liquid is not particularly limited. As examples, a method of dissolving the metal salt in water to obtain an aqueous solution containing the metal salt, adding the pore-forming agent to the solution, and dispersing the pore-forming agent in the solution, and a method of simultaneously carrying out dissolution and or dispersion of the metal salt and dispersion of the pore-forming agent can be given.

Next, the spray pyrolysis step will be described. The spray pyrolysis step is a step of spraying the dispersion liquid into a heating furnace to produce the powdery metal oxide particles (F) having cavities and cores.

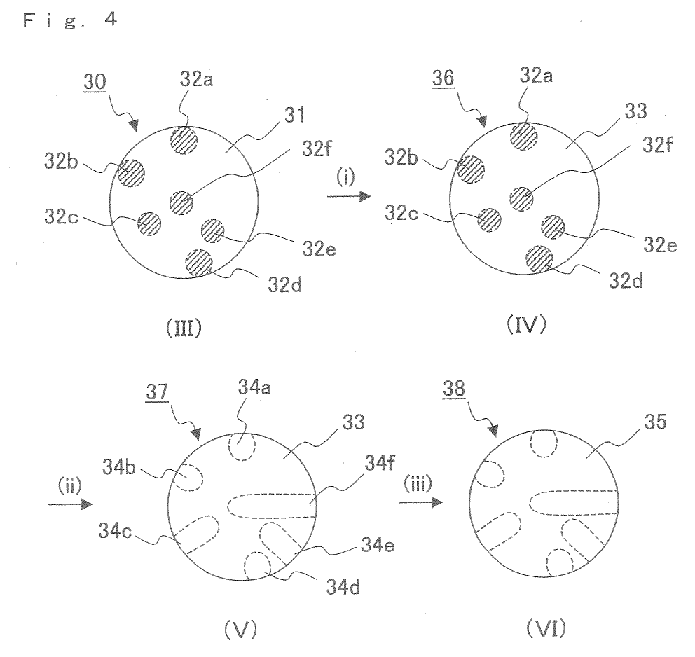

The spray pyrolysis step will be explained with reference to FIG. 4. FIG. 4 shows a schematic diagram illustrating the manner in which the powdery metal oxide particles (F) having cavities or pores are produced from a dispersion liquid in the spray pyrolysis step of the present invention. In FIG. 4, (III) shows a droplet 30 of the dispersion liquid before entering the heating furnace (hereinafter referred to from time to time simply as “dispersion liquid droplet 30”), (IV) shows a pore-forming agent-containing metal salt aggregate 36 containing carbon powder, (V) shows a metal salt aggregate 37 having cavities and pores, and (VI) shows the resulting metal oxide particles 38 having cavities and pores. In Figures (V) and (VI), dotted lines indicate inner borders of cavities and pores formed in the metal salt aggregate 37 having cavities and pores or the metal oxide aggregate 38 having cavities and pores.

The dispersion liquid droplet 30 is a droplet of the dispersion liquid immediately after being sprayed from a nozzle or the like. Particles of carbon powder 32 are dispersed in a spherical metal salt aqueous solution 31. At this time, although the carbon powder 32 is in the core of the dispersion liquid droplet 30, there are particles of carbon powder existing near the surface of the dispersion liquid droplet 30 (32a, 32b, and 32d) and particles of carbon powder existing inside the droplet away from the surface (32c, 32e, and 32f).

When the dispersion liquid droplet 30 is heated in a heating furnace, water evaporates from the dispersion liquid droplet 30, whereby the metal salt aqueous solution 31 is converted into a metal salt aggregate 33 to produce the pore-forming agent-containing metal salt aggregate 36 containing the carbon powder 32.

Next, the carbon powder 32 in the pore-forming agent-containing metal salt aggregate 36 burns. When the carbon powder 32 is burnt: cavities and pores are formed, whereby the metal salt aggregate 37 having cavities and pores is produced In this instance, when carbon powder particles 32a, 32b, and 32d existing close to the surface of the pore-forming agent-containing metal salt aggregate 36 are burnt downs cavity-like holes (34a, 34b, and 34d) are formed on the surface of the pore-forming agent-containing metal salt aggregate 36. In addition, when particles of carbon powder (32c, 32e, and 32f) existing inside the pore-forming agent-containing metal salt aggregate 36 away from the surface burnt, holes are formed in the area in which the carbon powder 32c and the like are burned and, at the same time, combustion gases such as carbon dioxide spout out toward the exterior of the pore-forming agent-containing metal salt aggregate 36, whereby continuous holes (34c, 34e, and 34f) are formed from the core toward the surface of the pore-forming agent-containing metal salt aggregate 36.

Then, the metal salt aggregate 33 of the metal salt aggregate 37 having cavities and pores is oxidized into a metal oxide aggregate 35, whereby metal oxide particles 38 having cavities and pores are produced.

In this manner, powdery metal oxide particles having cavities or pores can be produced in the spray pyrolysis step.

Namely, the spray pyrolysis step comprises (i) evaporating water from the dispersion liquid droplet, (ii) burning the pore-forming agent in the metal salt aggregate, and (iii) oxidizing the metal salt in the metal salt aggregate. The above (i), (ii), and (ii) may be carried out either simultaneously or stepwise.

The method of spraying the dispersion liquid in a heating furnace is not particularly limited. For example, a method of pressurizing the dispersion liquid with a pump and spraying droplets of the dispersion liquid from the tip of a nozzle, a method of using an ultrasonic spraying device, and a method of placing the dispersion liquid droplets on a rotatable disk and blowing away the droplets by a centrifugal force can be given.

The heating furnace may be either a one-stage heating furnace or a multi-stage heating furnace consisting of two or more heating furnaces connected to each other, but each set at a temperature differing from the temperature of other heating furnace(s). Each of the above (i), (ii), and (iii) is carried out at a different temperature. The temperature becomes higher in the order of (i), (ii), and (iii).

In the case of the one-stage heating furnace, all of (i) to (iii) are carried out in one heating furnace. In this instance, the temperature of the heating furnace is from 500° C. to 1,200° C., and preferably from 800° C. to 1,200° C.

When a two-stage heating furnace is used, the above (i) is carried out in the former stage and (ii) and (iii) are carried out in the latter stage. The temperature of the former stage is from 100° C. to 600° C., and preferably from 100° C. to 400° C., and the temperature of the latter stage is from 400° C. to 1,200° C., and preferably from 600° C. to 1,200° C. Alternatively, (i) and (ii) may be carried out in the former stage and (iii) is carried out in the latter stage, in which case the temperature of the former stage is from 100° C. to 800° C., and preferably from 300° C. to 800° C., and the temperature of the latter stage is from 600° C. to 1,200° C., and preferably from 800° C. to 1,200° C.

In addition, a three-stage heating furnace can be used, in which case the above (i) is carried out in the former stage heating furnace, (ii) is carried out in the middle stage heating furnace, and (iii) is carried out in the latter stage heating furnace. The temperature of the former stage is from 100° C. to 600° C., and preferably from 100° C. to 500° C., the temperature of the middle stage is from 400° C. to 800° C., and preferably from 600° C. to 800° C., and the temperature of the latter stage is from 600° C. to 1,200° C., and preferably from 800° C. to 1,200° C.

Moreover, it is possible to use a four-stage heating furnace. In this instance, the temperature of the first stage is from 100° C. to 400° C., and preferably from 100° C. to 300° C., the temperature of the second stage is from 300° C. to 700° C., and preferably from 300° C. to 600° C., the temperature of the third stage is from 500° C. to 1,200° C., and preferably from 600° C. to 800° C., and the temperature of the fourth stage is from 700° C. to 1,200° C., and preferably from 800° C. to 1,200° C.

It is possible to use a heating furnace with five or more stages and to more precisely divide the temperature scale for these stages.

The particles passing through the heating furnace are collected using a filter or the like to obtain the powdery metal oxide particles (F) having cavities and cores. The specific surface area of the powdery metal oxide particles (F) having cavities and cores is usually from 3 to 30 m ²/g, preferably from 4 to 25 m²/g, and particularly preferably from 5 to 20 m²/g.

According to the production process of the first embodiment, powdery metal oxide particles having cavities or pores can be prepared. Therefore, the production process of the first embodiment can be suitably used for the production of the powdery metal oxide mother particles and the powdery metal oxide child particles.

Next, a process for producing the powder metal oxide particles having cavities according to a second embodiment of the present invention (hereinafter referred to from time to time as “production process of the second embodiment”) will be described. The production process of the second embodiment comprises a precursor-producing step of applying a mechanical force to a mixture of powdery raw material metal oxide particles (the powdery raw material metal oxide particles indicate the powdery metal oxide particles before cavities are formed used as a raw material of the production process of the second embodiment) and the powdery pore-forming agent to obtain a powdery precursor and a sintering step of burning the powdery precursor to produce powdery metal oxide particles having cavities (hereinafter referred to from time to time as “powdery metal oxide particles having cavities (G)”).

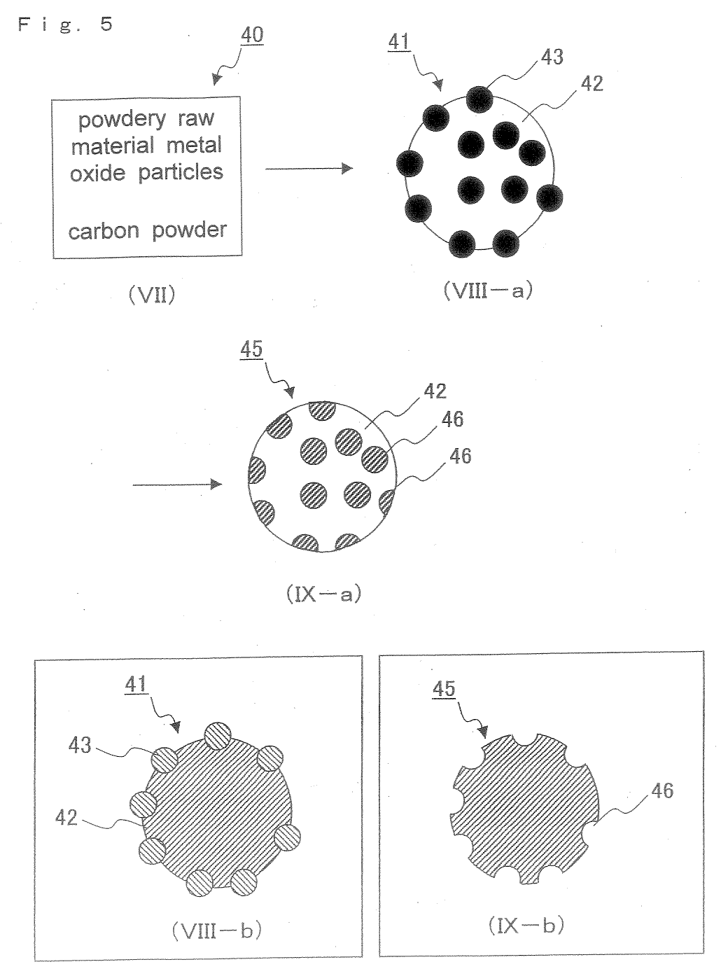

The powdery metal oxide particles having cavities (G) obtained by the production process of the second embodiment and the production mechanism thereof will be described with reference to FIG. 5. FIG. 5 shows a production mechanism of the powdery metal oxide particles having cavities (G) obtained by the production process of the second embodiment. In FIG. 5, (VII) shows a mixture 40 of the powdery raw material metal oxide particles and carbon powder, (VIII-a) shows an external appearance of a precursor 41, (VIII-b) shows a view of an arbitrary plane along which the precursor 41 was cut, (IX-a) shows an external appearance of the metal oxide particles having cavities (G) 45, and (IX-b) shows a view of an arbitrary plane along which the metal oxide particles having cavities (G) 45 were cut. The shadow area in the metal oxide particles having cavities (G) 45 in (IX-a) indicates cavities formed in the metal oxide particles having cavities (G) 45. First, the precursor 41, comprising raw material metal oxide particles 42 and carbon powder 43 fixed thereto, is produced by applying a mechanical force to the mixture 40 of the powdery raw material metal oxide particles and carbon powder (VIII-a). In this instance, the carbon powder 43 sinks into the raw material metal oxide particles 42 and fixes thereto (VIII-b) Next the precursor 41 is sintered to obtain the metal oxide particles having cavities (G) 45 in which cavities 46 are formed (IX-a). The cavities 46 are formed by burning down the carbon powder 43 (compare VIII-b and IX-b). Specifically, in the production process of the second embodiment, carbon particles on the surface of raw material metal oxide particles sink into the metal oxide particles, then tracks (marks) of the carbon particles remaining on the surface of the metal oxide particles after burning of the carbon powder become cavities in the metal oxide particles having cavities (G).

The powdery raw material metal oxide particles are aggregate (secondary particles) of metal oxide particles (primary particles), and differ according to the cases (11) when the powdery metal oxide particles having cavities (G) to be used as an electrolyte substance are produced, (12) when the powdery metal oxide particles having cavities (G) to be used as a fuel electrode substance are produced, (13) when the powdery metal oxide particles having cavities (G) to be used as an air electrode substance are produced, (14) when the powdery metal oxide particles having cavities (G) to be used as both an electrolyte substance and a fuel electrode are produced, and (15) when the powdery metal oxide particles having cavities (G) to be used as both an electrolyte substance and an air electrode are produced.

Except for the absence of cavities or pores, the raw material metal oxide particles in the case of (11) are the same as the above-mentioned powdery metal oxide mother particles (child particles) (A) in regard to metal oxides forming the metal oxide particles, the case of using two or more types of metal for forming the metal oxide, and the aggregate in the case of using two or more types of metals for forming the metal oxide. In addition, except for the presence or absence of cavities or pores, the raw material metal oxide particles used in the case of (12) are the same as the powdery metal oxide mother particles (child particles) (B), the raw material metal oxide particles used in the case of (13) are the same as the powder metal oxide mother particles (child particles) (C), the raw material metal oxide particles used in the case of (14) are the same as the powdery metal oxide mother particles (child particles) (D), and the raw material metal oxide particles used in the case of (15) are the sa e as the powdery metal oxide mother particles (child particles) (E).

Although not particularly limited, when the powdery metal oxide particles having cavities (G) are used as mother particles of the later-described composite particles, the average particle diameter of the raw material powdery metal oxide particles is preferably from 0.1 to 100 micrometers, particularly preferably from 0.1 to 20 micrometers, and still more preferably from 0.1 to 10 micrometers, and when the powdery metal oxide particles having cavities (G) are used as child particles of the composite particles, the average particle diameter is preferably from 0.01 to 10 micrometers, particularly preferably from 00.1 to 5 micrometers, and still more preferably from 0.01 to 1 micrometer.

The raw material powdery metal oxide particles can be obtained by using a method known in the art or by pulverizing or classifying commercially-available metal oxide particles.

In addition, the raw material powdery metal oxide particles may be the powdery metal oxide particles having cavities (G) produced by the production process of the second embodiment.

The pore-forming agent will be described regarding only to the features differing from those of the production process of the first embodiment description.

The average particle diameter of carbon powder, thermoplastic resin powder, or thermosetting resin powder used in the production process of the second embodiment depends on the average particle diameter of the powdery raw material metal oxide particles, but usually from 0.001 to 10 micrometers, preferably from 0.001 micrometers to 1 micrometer, and particularly preferably from 0.01 micrometers to 1 micrometer.

Although not particularly limited, the ratio of the average particle diameter of carbon powder, thermoplastic resin powder, or thermosetting resin powder to the average particle diameter of the powdery raw material metal oxide particles (carbon powder, etc/raw material metal oxide particles) is 0.001 to 0.5, preferably from 0.01 to 0.2, and particularly preferably from 0.01 to 0.1. The smaller the ratio of the average particle diameter of carbon powder, thermoplastic resin powder, or thermosetting resin powder to the average particle diameter of the powdery raw material metal oxide particles, the easier it is for the carbon powder, thermoplastic resin powder, or thermosetting resin powder to be fixed to the powdery raw material metal oxide particles. However, if the ratio is less than 0.001, not only must a large amount of carbon powder, thermoplastic resin powder, or thermosetting resin powder be blended, but also handling of the mixture is difficult, and if more than 0.5, it is difficult to fix the carbon powder, thermoplastic resin powder, or thermosetting resin powder to the powdery raw material metal oxide particles.

Although the average fiber length and the average fiber diameter of the thermoplastic resin fibers, thermosetting resin fibers, natural fibers, or derivatives of natural fibers used in the production process of the second embodiment depend on the average particle diameter of the powdery raw material metal oxide particles, the average fiber diameter is preferably from 0.01 to 50 micrometers, and particularly preferably from 0.1 to 10 micrometers, and the average fiber length is preferably from 0.01 to 100 micrometers, and particularly preferably from 0.1 to 50 micrometers.

Although not particularly limited, the ratio of the average fiber diameter of thermoplastic resin fibers, thermosetting resin fibers, natural fibers, or derivatives of natural fibers to the average particle diameter of the powdery raw material metal oxide particles (thermoplastic resin fibers, etc./raw material metal oxide particles) is usually from 0.001 to 0.5, preferably from 0.01 to 0.2, and particularly preferably from 0.01 to 0.1. The smaller the ratio of the average fiber diameter of the thermoplastic resin fibers, thermosetting resin fibers, natural fibers, or derivatives of natural fibers to the average particle diameter of the powdery raw material metal oxide particles, the easier it is for the thermoplastic resin fibers, thermosetting resin fibers, natural fibers, or derivatives of natural fibers to be fixed to the powdery raw material metal oxide particles. However, if the ratio of the average fiber diameter is less than 0.001, not only must a large amount of the thermoplastic resin fibers, thermosetting resin fibers, natural fibers, or derivatives of natural fibers be blended, but also handling of the mixture is difficult, and if more than 0.5, it is difficult to fix the thermoplastic resin fibers, thermosetting resin fibers, natural fibers, or derivatives of natural fibers to the powdery raw material metal oxide particles.

As the pore-forming agent, two or more of the carbon powder, thermoplastic resin powder, thermoplastic resin fibers, thermosetting resin powder, thermosetting resin fibers, natural fibers, and derivatives of natural fibers may be used in combination.

The ratio by weight of the pore-forming agent to the powdery raw material metal oxide particles in the mixture pore-forming agent/powdery raw material metal oxide particles) used in the precursor-producing step is usually from 0.001 to 1,000, preferably from 0.01 to 100, and particularly preferably from 0.01 to 10.

Then, a mechanical force is applied to the mixture of the powdery raw material metal oxide particles and the pore-forming agent to obtain powdery precursor material.

The method for applying a mechanical force to the mixture is not particularly limited. A known method of producing composite particles with child particles fixed to mother particles, for example, (iv) a method of applying a welding force and a shear force to the mixture and (v) a method of causing the pore-forming agent to collide with the powdery raw material metal oxide particles can be given.

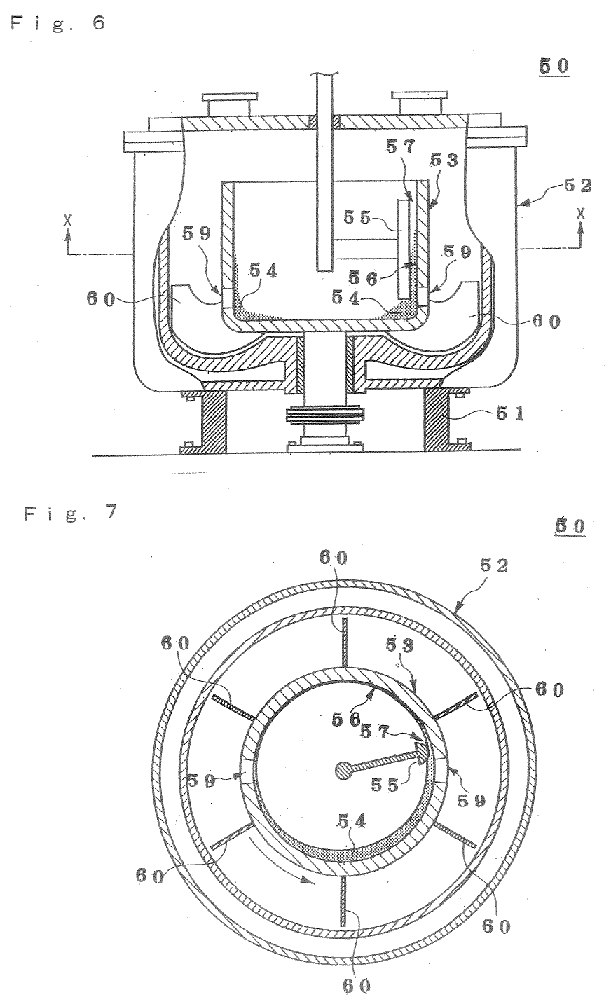

As an example of the method (iv), a method of applying a welding force and a shear force to the mixture using the powder processing unit shown in FIG. 6 can be given. The powder processing unit will be explained with reference to FIGS. 6 and 7. FIG. 6 is a schematic diagram showing a powder processing unit and FIG. 7 is a sectional view of a powder processing unit 50 cut along the X-X plane. In FIG. 6, a powder processing unit 50 is provided with an outer cylinder 52 installed on a seat 51, a rotating body 53 installed rotatably inside the outer cylinder 52, and a press head 55. The rotating body 53 has a hole 59 provided through the wall, and blade members 60 are attached to the rotating body 53 at fixed intervals around the outer circumference of the rotating body 53. The rotating body 53 and press head 55 are disposed to provide a space 57 between them.

A powder mixture 54 is added to the powder processing unit 50 and the rotating body 53 is rotated, whereby the powder mixture 54 is fed between the press head 55 and a receiving plane 56 of the rotating body 53, and a welding force and a shear force are applied to the powder mixture 54. The powder mixture 54 to which the welding force and shear force are applied is discharged to the outside of the rotating body 53 from the hole 59, and circulated to the inside of the rotating body 53 by the blade member 60.

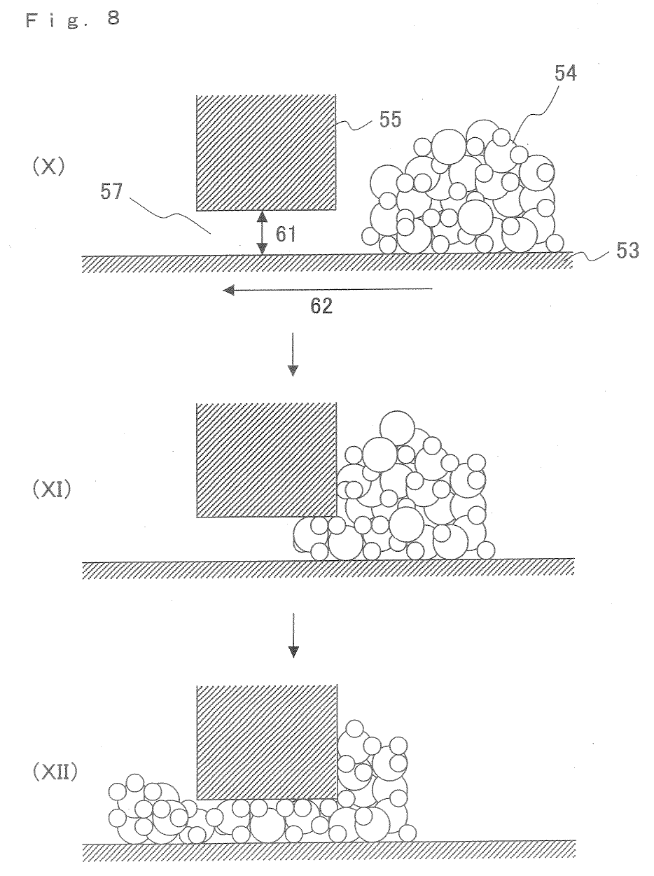

The manner in which a welding force and a shear force are applied to the powder mixture 54 in the powder processing unit 50 will be described with reference to FIG. 8. FIG. 8, which schematically shows the manner in which a welding force and a shear force are applied to a powder mixture 54, is an enlarged view of the area in which the welding force and the shear force are applied to the powder mixture 54 in the powder processing unit 50 shown in FIG. 7, that is, FIG. 8 is an enlarged view of the area in which the press head 55 and rotating body 53 sandwich the powder mixture 54. In FIG. 8, (X) shows the state before the welding force and the shear force are applied to the powder mixture 54, and (XI) and (XII) show the state when the welding force and shear force are being applied to the powder mixture 54. When the rotating body 53 (a moving member) moves toward the moving direction 62, the powder mixture 54 moves toward the press head 55 (a secured member), whereby the powder mixture 54 is fed to the space 57 by being sandwiched between the press head 55 and rotating body 53. At this time, a welding force is applied to the powder mixture 54 (XI). Next, when the rotating body 53 moves in a state in which the powder mixture 54 is sandwiched between the press head 55 and rotating body 53, a shear force is applied to the powder mixture 54 (XII). Therefore, in the method (iv) the welding force and the shear force are determined by the width (61 in (X)) between the secured member (press head 55) and the moving member (rotating body 53). Although the width between the secured member and the moving member (hereinafter referred to from time to time as “clearance”) can be appropriately adjusted according to the particle size of processed powder, that width is usually from 0.01 to 5 mm, and preferably from 0.1 to 2 mm. The moving speed is usually from 10 to 100 m/s, and preferably from 20 to 80 m/s. Although the press head 55 and receiving plane 56 have both a curved configuration in FIGS. 6 and 7, they are shown as a member with a flat plane in FIG. 8 for convenience of explanation.

In the method (iv) the mixture used in the precursor-producing step may be a slurry or a suspension containing the powdery raw material metal oxide particles and pore-forming agent.

In this method (iv) the pore-forming agent is dragged on the surface of the powdery raw material metal oxide particles while being pressed against the powdery raw material metal oxide particle with a strong force. As a result, the pore-forming agent sinks into the powdery raw material metal oxide particles and is fixed thereto.

As an example of the method (v), a surface treatment method of solid particles disclosed in JP-A-05-168895 can be given. Specifically, in this method, a mixture of the pore-forming agent and the powdery raw material metal oxide particles is fed to a rotating body equipped with an impact board to cause the mixture to collide with the impact board and to move together with a high-speed air flow produced by rotation of the impact board, thereby causing the mixture to repeatedly collide with the impact board. In the surface treatment method one of the particles in the mixture is sandwiched between other particles in the mixture when the mixture collides with the impact board, whereby collision takes place among the particles. Therefore, the force causing the mixture to collide is regulated by the speed of collision of the mixture in the method (v). Since the impact board moves in the surface treatment method, the speed of the impact board is relatively the speed of collision of the mixture. The moving speed of the impact board is usually from 10 to 100 m/s, and preferably from 20 to 80 m/s.

Next, a sintering step is carried out, in which the powdery precursor is burnt to obtain the powdery metal oxide particles (G) having pores.

The burning temperature in the sintering step is from 100° C. to 1,500° C., preferably from 100° C. to 1,000° C., and particularly preferably from 100° C. to 600° C. The period of time for which the sintering step is carried out is from ten minutes to five hours, preferably from ten minutes to two hours, and particularly preferably from ten minutes to one hour.

The powdery metal oxide particles (G) with many cavities on the surface can be obtained by performing the sintering step. The specific surface area of the powdery metal oxide particles having cavities (G) is usually from 3 to 30 m²/g, preferably from 4 to 25 m²/g, and particularly preferably from 5 to 20 m²/g.

It is possible to repeat the production process of the second embodiment by using the powdery metal oxide particles having cavities (G) as the powdery raw material metal oxide particles of the production process of the second embodiment.

According to the production process of the second embodiment, powdery metal oxide particles having cavities can be prepared. Therefore, the production process of the second embodiment can be suitably used for the production of the powdery metal oxide mother particles and the powdery metal oxide child particles.

The powdery composite particles of the present invention include (16) composite particles with child particles fixed to mother particles, wherein the mother particles are the powder metal oxide mother particles of the present invention, (17) composite particles with child particles fixed to mother particles, wherein the child particles are the powder metal oxide child particles of the present invention, and (18) composite particles with child particles fixed to mother particles, wherein the mother particles are the powdery metal oxide mother particles of the present invention and the child particles are the powder metal oxide child particles of the present invention.

The powdery composite particles will be explained with reference to FIG. 9. FIG. 9 is a schematic diagram showing a composite particle. In FIG. 9, the composite particle 70 comprises child particles 72 fixed to mother particles 71. Because the above-mentioned metal oxide mother particles (A) to (E) can be used as the mother particles 71 and the above-mentioned metal oxide child particles (A) to (E) can be used as the child particles 72, there are the combinations of the mother particles 71 and the child particles 72 shown in Tables 1 and 2. Table 1 shows combinations for producing fuel electrodes for solid oxide fuel cells and Table 2 shows combinations for producing air electrodes for solid oxide fuel cells. In the Tables 1 and 2, “particles for electrolyte substance (no pores)” refer to particles for producing fuel electrodes with no cavities or pores like particles used for producing conventional composite particles. This definition also applies to the terms “particles for fuel electrode substance (no pores)” and “particles for air electrode substance (no pores)”.

TABLE 1
Composite particles 70 for producing fuel electrode

| Mother particles 71 | Child particles 72 |
|---|---|
| Metal oxide mother particles (A) | Particles for fuel electrode substance (no pores) |
| Particles for fuel electrode substance (no pores) | Metal oxide child particles (A) |
| Particles for electrolyte substance (no pores) | Metal oxide child particles (B) |
| Metal oxide mother particles (B) | Particles for electrolyte substance (no pores) |
| Metal oxide mother particles (A) | Metal oxide child particles (B) |
| Metal oxide mother particles (B) | Metal oxide child particles (A) |
| Metal oxide mother particles (D) | Particles for fuel elecrode substance (no pores) |
| Particles for fuel electrode substance (no pores) | Metal oxide child particles (D) |
| Particles for electrolyte substance (no pores) | Metal oxide child particles (D) |
| Metal oxide mother particles (D) | Particles for electrolyte substance (no pores) |
| Metal oxide mother particles (A) | Metal oxide child particles (D) |
| Metal oxide mother particles (D) | Metal oxide child particles (A) |
| Metal oxide mother particles (D) | Metal oxide child particles (B) |
| Metal oxide mother particles (B) | Metal oxide child particles (D) |
| MEtal oxide mother particles (D) | Metal oxide child particles (D) |

TABLE 2
Composite particles 70 for producing air electrode

| Mother particles 71 | Child particles 72 |
|---|---|
| Metal oxide mother particles (A) | Particles for air electrode substance (no pores) |
| Particles for fuel electrode substance (no pores) | Metal oxide child particles (A) |
| Particles for electrolyte substance (no pores) | Metal oxide child particles (C) |
| Metal oxide mother particles (C) | Particles for electrolyte substance (no pores) |
| Metal oxide mother particles (A) | Metal oxide child particles (C) |
| Metal oxide mother particles (C) | Metal oxide child particles (A) |
| Metal oxide mother particles (E) | Particles for air electrode substance (no pores) |
| Particles for air electrode substance (no pores) | Metal oxide child particles (E) |
| Particles for electrolyte substance (no pores) | Metal oxide child particles (E) |
| Metal oxide mother particles (E) | Particles for electrolyte substance (no pores) |
| Metal oxide mother particles (A) | Metal oxide child particles (E) |
| Metal oxide mother particles (E) | Metal oxide child particles (A) |
| Metal oxide mother particles (E) | Metal oxide child particles (C) |
| Metal oxide mother particles (C) | Metal oxide child particles (E) |
| Metal oxide mother particles (E) | Metal oxide child particles (E) |

The specific surface area of the powdery composite particles is from 3 to 30 m²/g, preferably from 4 to 25 m²/g and particularly preferably from 5 to 20 m²/g.

The average particle diameter of the mother particles and the average particle diameter of the child particles are the same as those described in the description of the powdery metal oxide mother particles (child particles) of the present invention. Although not specifically limited, the ratio of the content of the average particle diameter of child particles to the average particle diameter of mother particles (child particles/mother particles) is preferably from 0.001 to 5, and particularly preferably from 0.01 to 0.1.

The powdery composite particles can be produced by fixing the child particles to the surface of the mother particles by applying a mechanical force to the mixture of the powder mother particles and the powder child particles of the above combinations.

The above-mentioned methods (iv) and (v) in the description of the production process of the second embodiment are applicable as the method for applying the mechanical force, except that the objects to be fixed are child particles.

Since the powdery composite particles of the present invention can be prepared using the powdery metal oxide mother particles or the powdery metal oxide child particles of the present invention they have a large specific surface area as compared with conventional composite particles.

The electrode for solid oxide fuel cells of the first embodiment of the present invention (hereinafter referred to from time to time as “electrode for solid oxide fuel cells (H)”) can be prepared by molding the powdery composite particles of the present invention into the shape of an electrode ((II) in FIG. 1). Specifically, the electrode is a fuel electrode for solid oxide fuel cells or an air electrode for solid oxide fuel cells obtained by molding the composite particles obtained by the combinations of the mother particles and child particles shown in Tables 1 and 2.

The method for producing the electrode for solid oxide fuel cells (H) using the powdery composite particles of the present invention is not specifically limited. Conventionally know methods of producing an electrode for solid oxide fuel cells by molding composite particles are appropriately employed. As an example, a doctor plate method can be given.

The electrode for solid oxide fuel cells of the second embodiment of the present invention (hereinafter referred to from time to time as “electrode for solid oxide fuel cells (J)”) is obtained by preparing a slurry containing one or more types of powdery metal oxide mother particles (A) to (E) of the present invention, molding the slurry into the form of an electrode, and baking the resulting molded article.

The method of molding the slurry containing the powdery metal oxide mother particles (A) to (E) is not particularly limited. Conventionally known methods of producing an electrode can be appropriately employed. As an example, a doctor plate method can be given.

Since the electrode for solid oxide fuel cells (H) and the electrode for solid oxide fuel cells (J) have a large surface area, these electrodes can provide a large amount of current per unit area and are free from a voltage decrease. Therefore, a battery having a high output density can be obtained by using the electrode for solid oxide fuel cells (H) or the electrode for solid oxide fuel cells (J).

The present invention will be described in more detail by examples, which should not be construed as limiting the present invention.

### EXAMPLES

### Example 1

(Preparation of Dispersion Liquid)

Yttrium nitrate (4.40 g) and zirconia nitrate dihydrate (22.45 g) were weighed and added to 100 ml of purified water. The mixture was heated to 50° C. to 80° C. while stirring to obtain an aqueous solution. 1.5 mass % of polystyrene particles with an average particle diameter of 0.203 micrometers (“Uniform Particle” manufactured by Seradyn Co.) were added to the solution and the mixture was stirred to obtain a dispersion liquid.

(Spray Pyrolysis)

Next, the dispersion liquid was sprayed into an electric furnace of an ultrasonic spray pyrolysis apparatus (manufactured by Nishiyama Seisakusho Co., Ltd.) having former, middle, and latter stages respectively set to 300° C., 650° C., and 1,000° C. at an air flow rate of 1 L/min. Particles passing through the latter stage filter were collected by Teflon (trademark) filter to obtain powdery metal oxide particles (i). The powdery metal oxide particles (i) had a particle diameter of 0.25 to 1.5 micrometers, an average particle diameter of 0.85 micrometer, and a specific surface area of 15.8 m²/g. As a result of X-ray diffraction analysis, the particles were confirmed to be yttria-stabilized zirconia with a Y₂O₃ content of 8 mol %.

(Observation by Scanning Electron Microscope)

The surface of the powdery metal oxide particles (i) was inspected using a scanning electron microscope to confirm pores with a pore size of 0.1 to 0.2 micrometer.

(Observation by Transmission Electron Microscope)

The powdery metal oxide particles (i) were added to a melted epoxy resin in a 10 mm×10 mm container. The mixture was cooled to obtain the powdery metal oxide particles (i) enveloped by the epoxy resin. The enveloped particles (i) were cut using a super-microtome to obtain a analytical sample with a thickness of 0.05 micrometer. The analytical sample was observed using a transmission electron microscope to confirm continuous holes inside the powdery metal oxide particles (i).

### Example 2

(Preparation of Dispersion Liquid and Spray Pyrolysis)

Powdery metal oxide particles (ii) were prepared in the same manner as in Example 1, except for using 2.91 g of nickel nitrate hexahydrate instead of yttrium nitrate (4.40 g) and zirconia nitrate dihydrate (22.45 g). The powdery metal oxide particles (ii) had a particle diameter of 0.2 to 0.5 micrometers, an average particle diameter of 0.28 micrometer, and a specific surface area of 16.2 m²/g. As a result of X-ray diffraction analysis, the particles were confirmed to be nickel oxide.

(Observation by Scanning Electron Microscope)

The surface of the powdery metal oxide particles (ii) was inspected in the same manner as in Example 1 to confirm pores with a pore size of 0.1 to 0.2 micrometer on the surface. An SEM photograph is shown in FIG. 3.

(Observation by Transmission Electron Microscope)

The powdery metal oxide particles (ii) were inspected in the same manner as in Example 1 to confirm continuous holes inside the particles.

### Example 3

(Preparation of Dispersion Liquid and Spray Pyrolysis)

Powdery metal oxide particles (iii) were prepared in the same manner as in Example 1, except for using lanthanum nitrate hexahydrate (3.12 g), strontium nitrate (0.38 g), and manganese nitrate hexahydrate (2.87 g) instead of yttrium nitrate (4.40 g) and zirconia nitrate dihydrate (22.45 g). The powdery metal oxide particles (iii) had a particle diameter of 0.2 to 3.0 micrometers, an average particle diameter of 1.80 micrometers, and a specific surface area of 6.8 m²/g. As a result of X-ray diffraction analysis, the particles were confirmed to be lanthanum strontium manganate (La_{0.8}Sr_{0.2}MnO₃).

(Observation by Scanning Electron Microscope)

The surface of the powdery metal oxide particles (iii) was inspected in the same manner as in Example 1 to confirm pores with a pore size of 0.1 to 0.2 micrometer on the surface.

(Observation by Transmission Electron Microscope)

The powdery metal oxide particles (iii) were inspected in the same manner as in Example 1 to confirm continuous holes inside the particles

### Example 4

(Preparation of Composite Particles)

Yttrium nitrate (13.2 g) and zirconia nitrate dihydrate (67.35 g) were weighed and added to 100 ml of purified water. The mixture was heated to 50° C. to 80° C. while stirring to obtain an aqueous solution. Next, the aqueous solution was sprayed into an electric furnace of an ultrasonic spray pyrolysis apparatus used in Example 1 having former middle, and latter stages respectively set to 300° C., 650° C., and 1,000° C. at an air flow rate of 1 L/min. Particles passing through the latter stage filter were collected by Teflon (trademark) filter to obtain powdery metal oxide particles (iv). The powdery metal oxide particles (iv) had a particle diameter of 5 to 10 micrometers, a average particle diameter of 6.5 micrometers, and a specific surface area of 1.2 m²/g. As a result of X-ray diffraction analysis, the particles were confirmed to be yttria-stabilized zirconia with a Y₂O₃ content of 8 mol %.

A 1:1 powder mixture of mother particles and child particles was prepared by mixing the powdery metal oxide particles (ii) obtained in Example 2 as child particles and the powdery metal oxide particles (iv) as mother particles. The powdery mixture was charged to a powder processing unit shown in FIG. 6 (manufactured by Hosokawa Micron Corp., head clearance: 1.19 m). A welding force and a shear force were applied to the powder mixture by rotating the rotating body at 1,400 rpm (a rotating body speed: 20 m/s) to obtain powdery composite particles (v). The specific surface area of the resulting powdery composite particles was 9.2 m/²/g.

(Preparation of Electrode)

The powdery composite particles (v), isopropyl alcohol used as a solvent, and polyvinyl butyral used as a binder were mixed to obtain a slurry. The slurry was filmed by a doctor plate method to obtain an electrode tape. The electrode tape was baked at 1,400° C. to produce an electrode.

### Example 5

(Preparation of Dispersion Liquid)

Lanthanum nitrate hexahydrate (3.12 g), strontium nitrate (0.38 g), and manganese nitrate hexahydrate (2.8 g) were weighed and added to 100 ml of purified water. The mixture was heated to 50° C. to 80° C. while stirring to obtain an aqueous solution. 1.5 mass % of polymethyl methacrylate particles with an average particle diameter of 400 nm (manufactured by Soken Chemical & Engineering Co., Ltd.) was added to the aqueous solution and the mixture was stirred to obtain a dispersion liquid.

(Spray of Dispersion Liquid)

Next, the dispersion liquid was sprayed into an electric furnace of an ultrasonic spray pyrolysis apparatus (manufactured by Nishiyama Seisakusho Co., Ltd.) having former, middle, and latter stages respectively set to 300° C., 650° C., and 1000° C. at an air flow rate of 1 L/min. Particles passing through the latter stage filter were collected by Teflon (trademark) further to obtain powdery metal oxide particles (vi). The powdery metal oxide particles (vi) had a particle diameter of 0.2 to 2 micrometers, an average particle diameter of 1.5 micrometers, and a specific surface area of 10.2 m²/g. As a result of X-ray diffraction analysis, the particles were confirmed to be lanthanum strontium manganate (La_{0.8}Sr_{0.2}MnO₃).

(Observation by Scanning Electron Microscope)

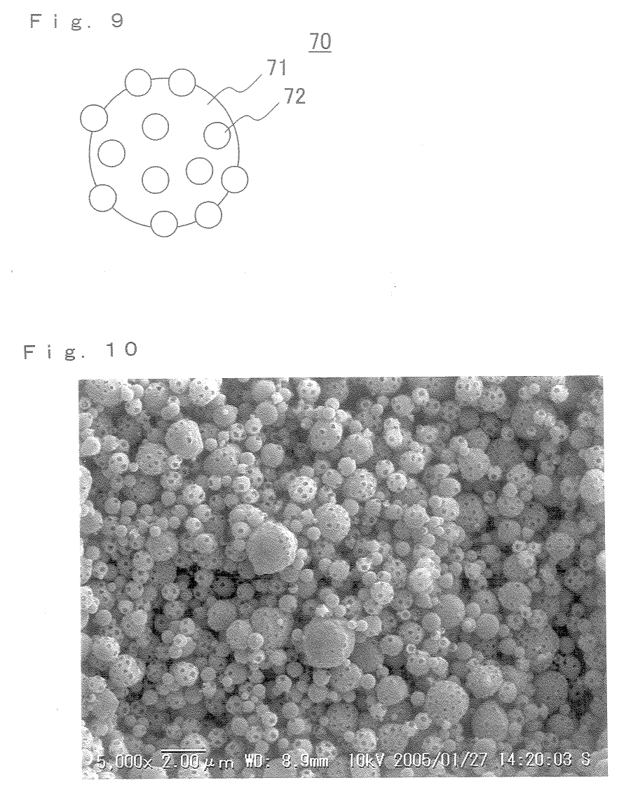

The surface of the powdery metal oxide particles (iv) was inspected using a scanning electron microscope to confirm pores with a pore size of 0.2 micrometers as shown in FIG. 10.

(Observation by Transmission Electron Microscope)

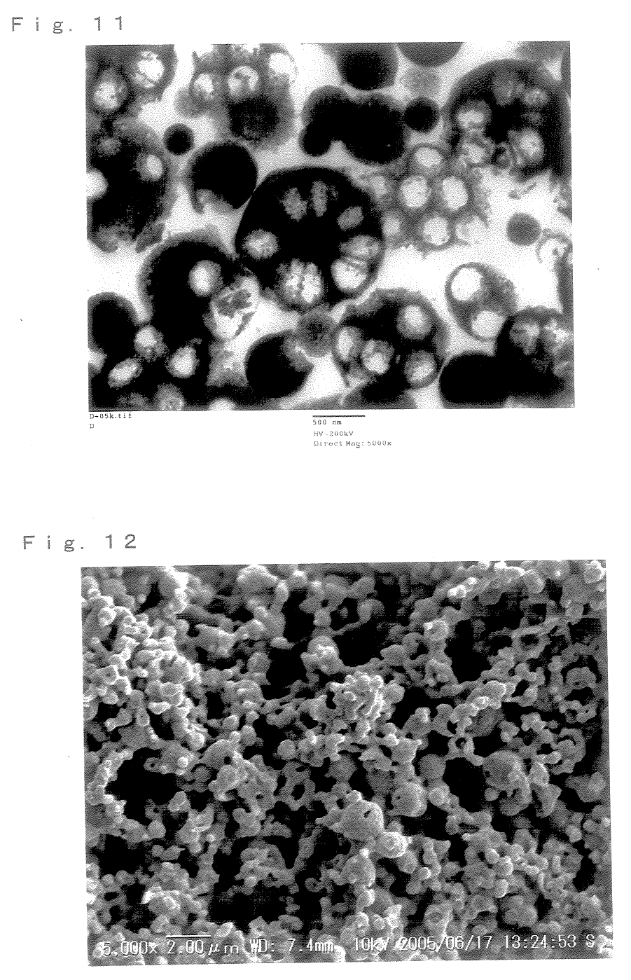

The powdery metal oxide particles (iv) were added to a melted epoxy resin in a 10 mm×10 mm container. The mixture was cooled to obtain the powdery metal oxide particles (vi) enveloped by the epoxy resin. The enveloped particles (i) were cut using a super-microtome to obtain an analytical sample with a thickness of 0.0 micrometer. The analytical sample was observed using a transmission electron microscope to confirm many pores formed also inside the powdery metal oxide particles (vi) as shown in FIG. 11.

(Preparation of Electrode)

Powdery metal oxide particles (vi) and scandia-stabilized zirconia powder (ScSZ; containing 10 mol % of Sc₂O₃ in ZrO₂, average particle diameter: 0.5 micrometers) were mixed at a mass ratio of 80:20. The mixture was added to an isopropyl alcohol solvent Polyvinyl butyral was added as a binder and mixed to obtain a slurry for forming an electrode. The slurry for forming an electrode was filmed by a doctor plate method to obtain an electrode tape. The electrode tape was baked at 1,250° C. to produce an electrode (vii).

(Observation by Scanning Electron Microscope)

The surface of the electrode (vii) was inspected using a scanning electron microscope. The results are shown in FIG. 12.

(Evaluation of Electrode Performance)

The slurry for forming electrode used for preparing the electrode (vii) was screen-printed on one of the surfaces of the sintered particle (diameter: 16 mm thickness: 2 mm) of scandia-stabilized zirconia to obtain a film with a thickness of 30 micrometers and a diameter of 6 mm. Then, platinum was screen-printed in the same manner on another surface, and baked at 1,250° C. A platinum net with platinum wires was pressed against the both surfaces and a platinum wire was wound around the side of the zirconia sintered article to obtain a reference electrode. The reaction resistance of an oxygen reduction reaction was determined in oxygen at 1,000° C. using an AC impedance method to confirm that the reaction resistance was 0.16 ohm-cm².

### INDUSTRIAL APPLICABILITY

A solid oxide fuel cell with a high output can be obtained according to the present invention.

1. Powdery metal oxide mother particles used in an electrode for solid oxide fuel cells, which have cavities or pores.

2. The powdery metal oxide mother particles according to claim 1, wherein the particles have a specific surface area of 3 to 30 m²/g.

3. Powdery metal oxide child particles used in an electrode for solid oxide fuel cells, which have cavities or pores.

4. The powdery metal oxide child particles according to claim 3, wherein the particles have a specific surface area of 3 to 30 m²/g.

5. A process for producing powdery metal oxide particles having cavities or pores, comprising preparing a dispersion liquid containing a metal salt and a pore-forming agent and spraying the dispersion liquid in a heating furnace to prepare powdery metal oxide particles having cavities or pores.

6. Powdery composite particles comprising mother particles and child particles fixed to the mother particles, in which the mother particles are the powdery metal oxide mother particles according to claim 1.

7. Powdery composite particles comprising mother particles and child particles fixed to the mother particles in which the child particles are the powdery metal oxide child particles according to claim 3.

8. Powdery composite particles comprising mother particles and child particles fixed to the mother particles in which the mother particles are powdery metal oxide mother particles used in an electrode for solid oxide fuel cells, which have cavities or pores, and the child particles are powdery metal oxide child particles used in electrode for solid oxide fuel cells, which have cavities or pores.

9. An electrode for solid oxide fuel cells obtained by molding the powdery composite particles according to claim 6.

10. An electrode for solid oxide fuel cells obtained by preparing a slurry containing one or more types of powdery metal oxide mother particles according to claim 1, molding the slurry into the form of an electrode and baking the resulting molded article.

11. An electrode for solid oxide fuel cells obtained by molding the powdery composite particles according to claim 7.

12. An electrode for solid oxide fuel cells obtained by molding the powdery composite particles according to claim 8.
